(19) United States
(12) Patent Application Publication
(10) Pub. No.: US 2018/0257721 A1
(43) Pub. Date: Sep. 13, 2018

(54) FOLDABLE UTILITY TRAILER

(71) Applicant: Scott JOHNSON, Edmonton (CA)

(72) Inventor: Scott JOHNSON, Edmonton (CA)

(21) Appl. No.: 15/916,780

(22) Filed: Mar. 9, 2018

Related U.S. Application Data
(60) Provisional application No. 62/469,598, filed on Mar. 10, 2017.

(51) Int. Cl. B62D 63/06

(52) U.S. Cl. CPC B62D 63/061; B62D 63/062

(57) ABSTRACT

A foldable utility trailer has a frame, a trailer bed, at least one axle, a coupler and a locking mechanism. The frame has a front end, a back end, a first segment adjacent the front end and a second segment adjacent the back end. The first segment of the frame is pivotally attached to the second segment of the frame such that the frame is foldable between a storage orientation and a hauling orientation. The trailer bed is supported by the frame. The trailer bed has a first portion corresponding to the first segment of the frame and a second portion corresponding to the second segment of the frame. The at least one axle is attached to the frame and has at least one wheel. The coupler is connected to the front end of the frame and is used to hook up to a hitch on a towing vehicle. The locking mechanism locks the frame into the storage orientation or the hauling orientation.

### FIELD OF THE DISCLOSURE

The present application relates generally to a foldable utility trailer. More specifically, the present application relates to a foldable utility trailer that may double as a work bench.

### BACKGROUND

This section provides background information to facilitate a better understanding of the various aspects of the invention. It should be understood that the statements in this section of this document are to be read in this light, and not as admissions of prior art.

When not in use, utility trailers are often stored where they are protected from inclement weather to avoid damage. In an attempt to limit storage space requirements, utility trailers that are capable of being folded into a smaller foot print have been used. While in storage, these foldable trailers take up valuable space where other items could be stored or work benches could be placed.

### BRIEF SUMMARY

There is provided a foldable utility trailer that has a foldable frame. The frame has a front end, a back end, a first segment adjacent the front end and a second segment adjacent the back end. The first segment of the frame is pivotally attached to the second segment of the frame such that the frame is foldable between a storage orientation and a hauling orientation. A trailer bed is supported by the frame. The trailer bed has a first portion corresponding to the first segment of the frame and a second portion corresponding to the second segment of the frame. At least one axle is attached to the frame and has at least one wheel. A coupler is connected adjacent to the front end of the frame to allow the trailer to be coupled to the hitch of a towing vehicle. A locking mechanism is provided for locking the frame in the storage orientation or the hauling orientation.

In one embodiment, a ramp is pivotally connected to the back end of the frame. The ramp may be removably connected to the back end of the frame. This allows for different lengths and types of ramps to be used.

In one embodiment, the ramp is foldable at an angle perpendicular to the second segment of the frame when in the storage orientation to create a work bench surface. Different ramps may provide different sizes of work bench surfaces.

In one embodiment, the coupler is removably connected to the front end of the frame. This allows for different types of couplers to be used depending upon the type of hitch being used on the towing vehicle.

In one embodiment, the coupler is spaced from the front end of the frame by at least one stabilization bar. The at least one stabilization bar has a first end attached to the coupler and a second end removably attached to the front end of the frame.

In one embodiment, the first segment of the frame is twice as a long as the second segment of the frame. The length of the second segment determines the height of the work bench surface when a ramp is used for that purpose in the storage orientation.

In one embodiment, the ramp has a first section and a second section. The first section is connected to the back end of the frame and the first section is pivotally attached to the second section. The second section of the ramp may be in telescopic communication with the first section such that the second section of the ramp fits inside the first section of the ramp.

In one embodiment, the second section of the ramp is foldable at an angle perpendicular to the first section of the ramp such that it acts as a floor support for the first section of the ramp when folded to create the work bench surface.

In one embodiment, at least one support is removably attachable to the frame adjacent a rear end of the first segment of the frame for supporting the frame when in the storage orientation.

In another embodiment, at least one support is removably attachable to the frame adjacent a forward end of the second segment of the frame for supporting the frame when in the storage orientation. The at least one support may have at least one wheel to allow for ease of movement of the foldable utility trailer when in the storage orientation.

In one embodiment, the foldable utility trailer has removable side panels attached to the frame. The removable side panels help to prevent items resting on the trailer bed from sliding off of the trailer bed. The removable side panels may have at least one connector that corresponds to at least one connector receptacle attached to the frame. This would allow users to quickly remove or replace the side panels as needed.

In one embodiment, the removable side panels are used to create a shelving unit. The removable side panels are removed from the frame of the foldable utility trailer and may be positioned on a wall or shelving frame using brackets or other means of hanging them. This allows the side panels to serve a useful purpose when not in use on the foldable utility trailer.

In one embodiment, the axle is attached to the second segment of the frame adjacent the forward end of the second segment of the frame. When in the folded position and where a ramp is provided, the axle is hidden under the work bench surface.

In one embodiment, the locking mechanism has a removable pin, a first locking aperture in communication with the second segment of the frame and a second locking aperture in communication with the first segment of the frame. The removable pin is sized to slide into the first locking aperture and the second locking aperture.

In one embodiment, a winch is used to fold the frame into the storage orientation. The winch may be removably mounted to the coupler and/or pivotally mounted to the coupler. The winch may be operated by hand or by motor.

In one embodiment, a receiver wheel is removably attachable to the coupler for use during the folding process. Prior to folding the trailer, receiver wheel is attached to the coupler. Receiver wheel prevents dragging of the coupler on the ground during folding. Receiver wheel may be removed from the coupler once trailer is in the storage orientation. The receiver wheel is removed from the coupler prior to hitching up the trailer to a tow vehicle.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a foldable utility trailer in an unfolded orientation.

FIG. 2 is a perspective view of the foldable utility trailer in an unfolded orientation.

FIG. 3 is a perspective view of the foldable utility trailer folded in half.

FIG. 4 is a perspective view of the foldable utility trailer folded to form a work table.

FIG. 5 is a front elevation view, partially in section, of the foldable utility trailer folded to form a work bench.

FIG. 6 is a perspective view of the foldable utility trailer in an unfolded orientation and having removable sides attached.

FIG. 7 is a perspective view of the foldable utility trailer shown in FIG. 5 with two side panels removed and used to create shelving.

FIG. 8 is a perspective view of a bracket used to support side panels as shelves.

FIG. 9 is a side elevation view of a hinge used to attach the first segment and the second segment of the frame.

FIG. 10 is a side elevation view of the hinge shown in FIG. 9 during the folding of the frame where the first segment of the frame is vertical in orientation and the second segment of the frame is moving into the storage orientation.

FIG. 11 is a perspective view, partially in section, of the foldable utility trailer with a receiver wheel.

### DETAILED DESCRIPTION OF THE PREFERRED EMBODIMENTS

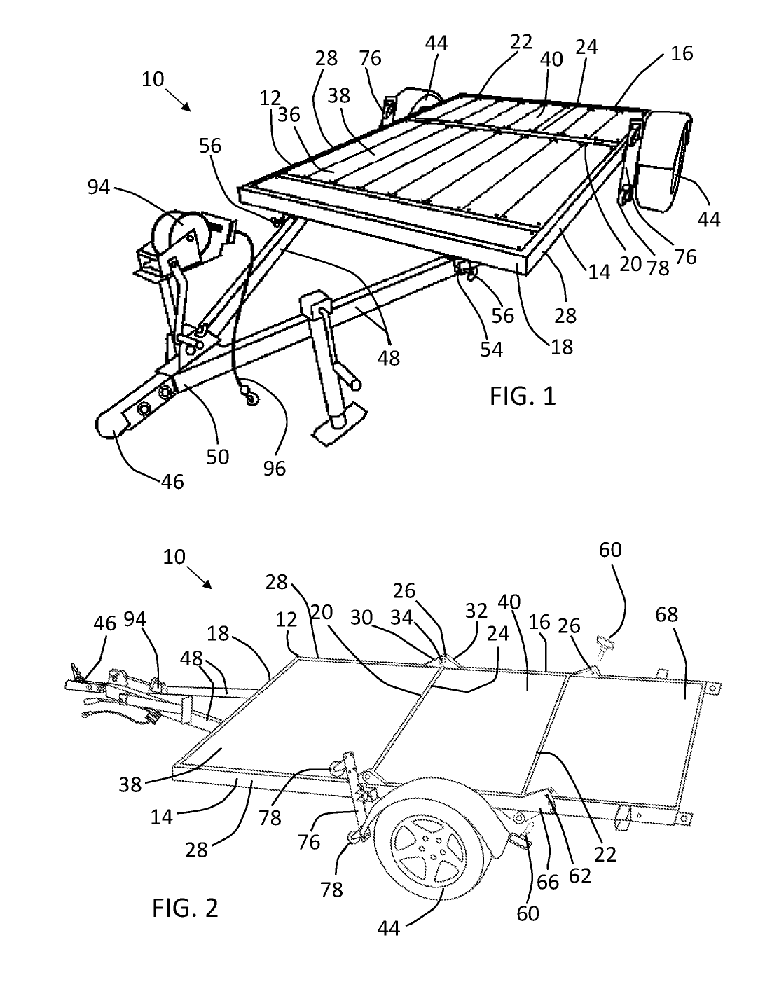

A foldable utility trailer, generally identified by reference numeral 10, will now be described with reference to FIG. 1 through FIG. 11.

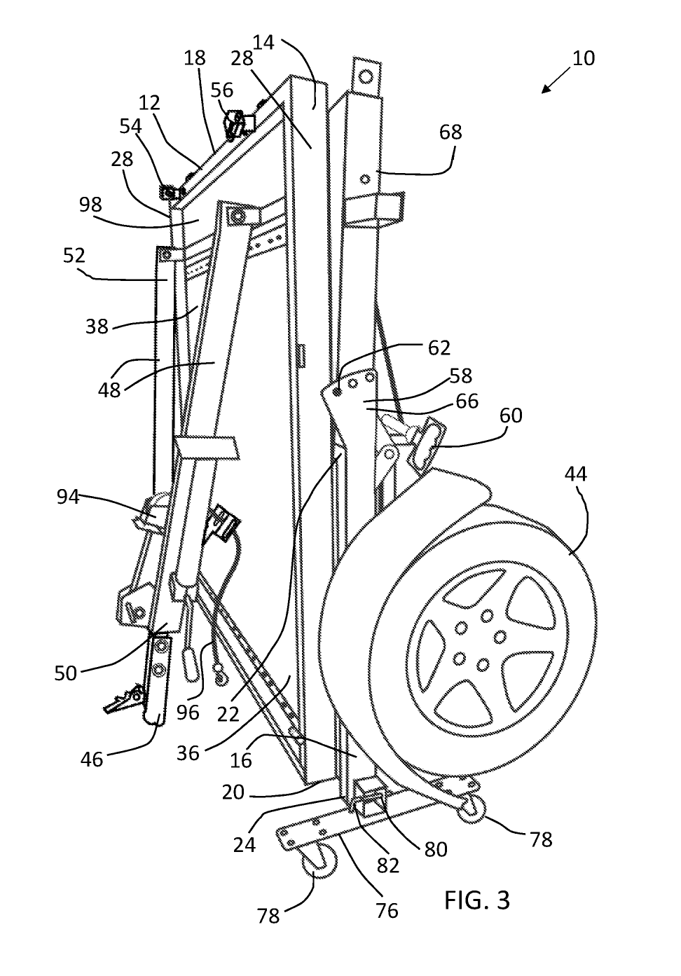

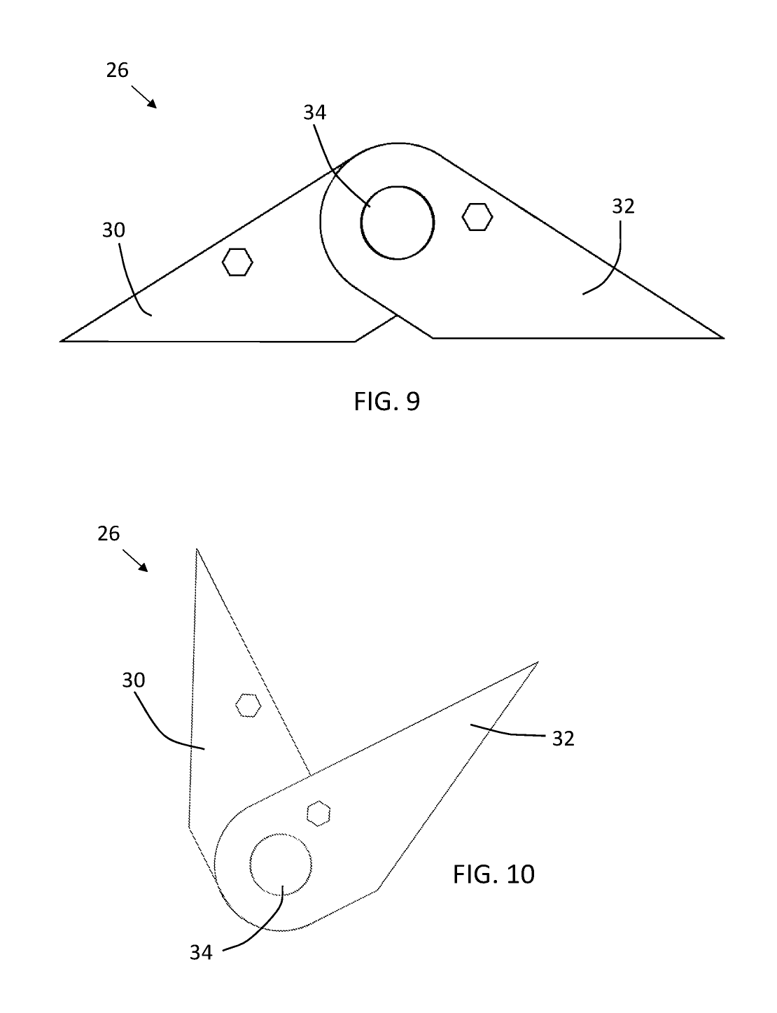

Referring to FIG. 2, foldable utility trailer 10 has a frame 12 made up of a first segment 14 and a second segment 16. First segment 14 of frame 12 has a front end 18 and a rear end 20 and second segment 16 has a back end 22 and a forward end 24. In the embodiment shown, first segment 14 and second segment 16 are both rectangular in shape, however it will be understood by a person skilled in the art that first segment 14 and second segment 16 may have different shapes. First segment 14 of frame 12 is pivotally attached to second segment 16 of frame 12 such that frame 12 is foldable between a storage orientation, shown in FIG. 3, and a hauling orientation, shown in FIG. 1. Referring to FIG. 2, in the embodiment shown, hinges 26 on opposed sides 28 of first segment 14 and second segment 16 adjacent rear end 20 and forward end 24, respectively, are provided. It will be understood by a person skilled in the art that different types of pivotal connections may be used. Referring to FIG. 9 and FIG. 10, in the embodiment shown, hinges 26 are made up of a first bracket 30 and a second bracket 32. First bracket 30 and second bracket 32 are pivotally attached at a pivot point 34. Referring to FIG. 2, first bracket 30 is fixedly attached to first segment 14 and second bracket 32 is fixedly attached to second segment 16. It will be understood by a person skilled in the art that different hinges, such as but not limited to piano hinges and door hinges, may also be used.

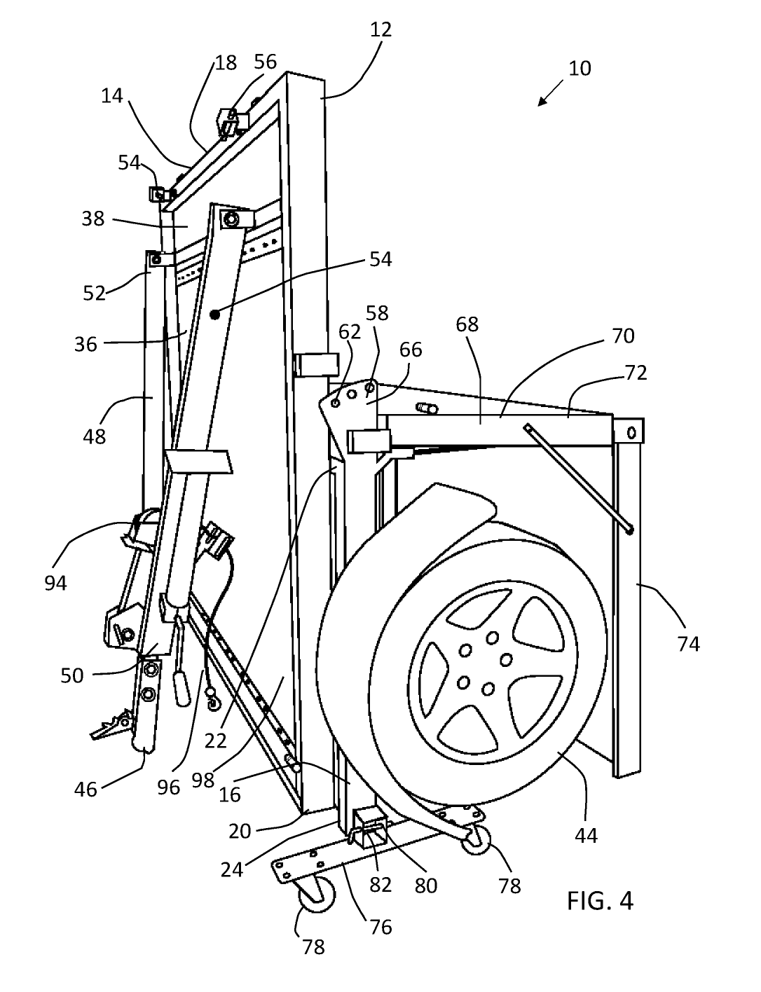

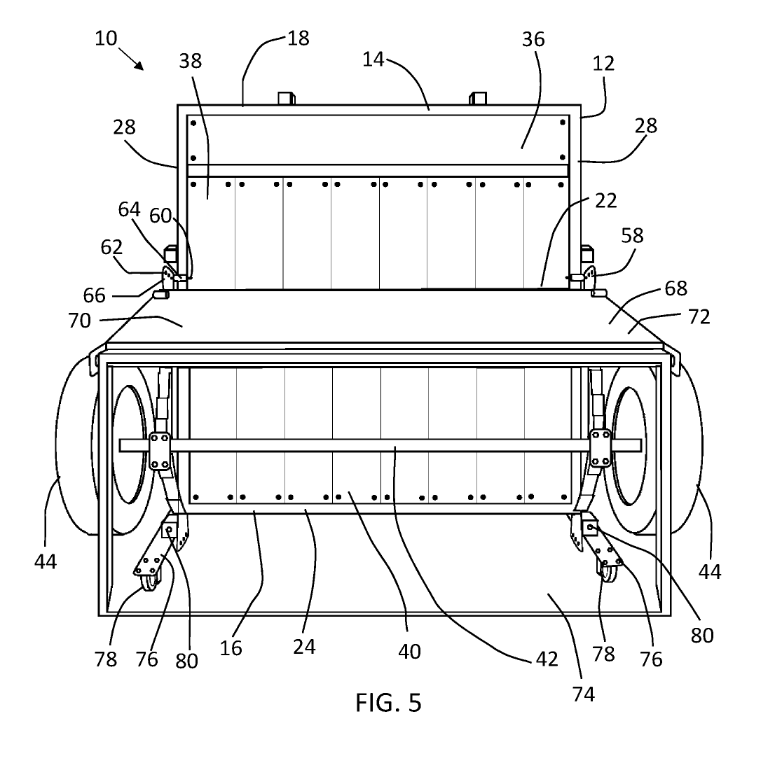

Referring to FIG. 4, in the embodiment shown, first segment 14 of frame 12 is about twice as long as second segment 15 of frame 12. It will, however, be understood by a person skilled in the art that first segment 14 and second segment 16 of frame 12 may be the same length or different lengths depending upon the overall length of trailer 10 and the desired storage size. A trailer bed 36 is supported by frame 12. Referring to FIG. 5, Trailer bed 36 has a first portion 38 corresponding to first segment 14 of frame 12 and a second portion 40 corresponding to second segment 16 of frame 12. At least one axle 42 is attached to frame 12 and has at least one wheel 44. In the embodiment shown, a single axle 42 with wheels 44 on opposed ends is used and axle 42 is attached to second segment 16 of frame 12 adjacent forward end 24. It will be understood by a person skilled in the art that placement of axle 42 may be changed. Additional axles may be needed for trailers with longer frames or where additional support is required. Referring to FIG. 1, a coupler 46 is connected to front end 18 of frame 12.

In the embodiment shown, coupler 46 is spaced from front end 18 of frame 12 by two stabilization bars 48. Referring to FIG. 3, stabilization bars 48 have a first end 50 attached to coupler 46 and a second end 52 removably and pivotally attached to front end 18 of frame 12. Stabilization bars 48 are locked into the hauling orientation through the use of apertures 54 and safety pins 56. When safety pins 56 are removed, stabilization bars 48 and coupler 46 may pivot in relation to first segment 14 of frame 12. A person of skill will understand that a single stabilization bar 48 or multiple stabilization bars 48 may be used.

Referring to FIG. 5, a locking mechanism 58 locks frame 12 in the storage orientation. In the embodiment shown, locking mechanism 58 has a removable pin 60 that is sized to slide into a first locking aperture 62 in communication with second segment 16 of frame 12 and a second locking aperture 64 in communication with first segment 14 of frame 12. In the embodiment shown, first locking aperture 62 is positioned on a dove tail 66 attached to second segment 16 of frame 12 and second locking aperture 64 is found on an opposed side 28 of first segment 14 of frame. A lynch pin, not shown, may be used to prevent removable pin from sliding out of engagement with locking aperture. It will be understood by a person skilled in the art that different types of locking mechanisms may be used. Locking mechanisms 58 may be present on both opposed sides 28 of frame 12.

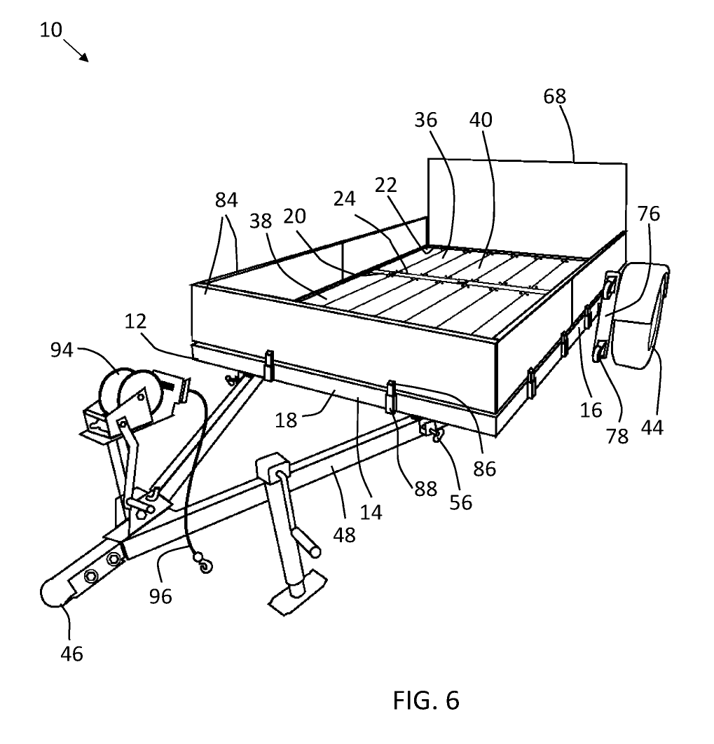

Referring to FIG. 6, a ramp 68 is pivotally connected to back end 22 of frame 12. Referring to FIG. 2, in the embodiment shown, ramp 68 is connected to frame 12 using hinges 26. It will be understood by a person skilled in the art that types of pivotal connections may be used. Ramp 68 may be removable to allow for different types and lengths of ramps 68 to be used. Referring to FIG. 4, ramp 68 is foldable at an angle perpendicular to second segment 16 of frame 12 when in the storage orientation to create a work bench surface 70. The height of work bench surface 70 is determined by the length of second segment 16 of frame 12 where a longer second segment 16 will result in a higher work bench surface 70 and a shorter second segment 16 will result in a lower work bench surface 70. The depth of work bench surface 70 is dependent upon the length of ramp 68. Depending on the type of ramp 68 used and the materials it is made out of, a flat surface, such as a piece of wood sized to fit the work bench surface 70, may be used to create a more effective surface for work or storage. Referring to FIG. 2, ramp 68 may be locked into a horizontal orientation using removable pins 60 in association with hinges 26 and first locking aperture 62 such that it acts as an extension of trailer frame 12 and trailer bed 36. This allows oversized items to be better supported. In the embodiment shown in FIG. 4, ramp 68 has a first section 72 and a second section 74. First section 72 is connected to back end 22 of frame 12 and is pivotally attached to second section 74. While not shown, second section 74 of ramp 68 may be in telescopic communication with first section 72 such that second section 74 of ramp 68 fits inside first section 72 of ramp 68. When in the storage orientation, second section 74 of ramp 68 is foldable at an angle perpendicular to first section 72 of ramp 68 such that it acts as a support for first section 72 of ramp when folded to create work bench surface 70. This may help to prevent first section 72 of ramp from tilting forward while in use. A removable leg, not shown, may also be used as a support when second section 74 of ramp is unavailable.

Referring to FIG. 1, in the embodiment shown, two supports 76 are removably attachable to frame 12 adjacent a forward end 24 of second segment 16 of frame 12 for supporting frame 12 when in the storage orientation, shown in FIG. 3. Referring to FIG. 3, supports 76 have a pair of wheels 78 to allow for ease of movement when trailer 10 is in the storage orientation. A person of skill will understand that a single central support could be used, or that support 76 could be attachable to frame 12 adjacent rear end 20 of first segment 14 of frame 12. In the embodiment shown, supports 76 are connected through the use of apertures 80 and pins 82.

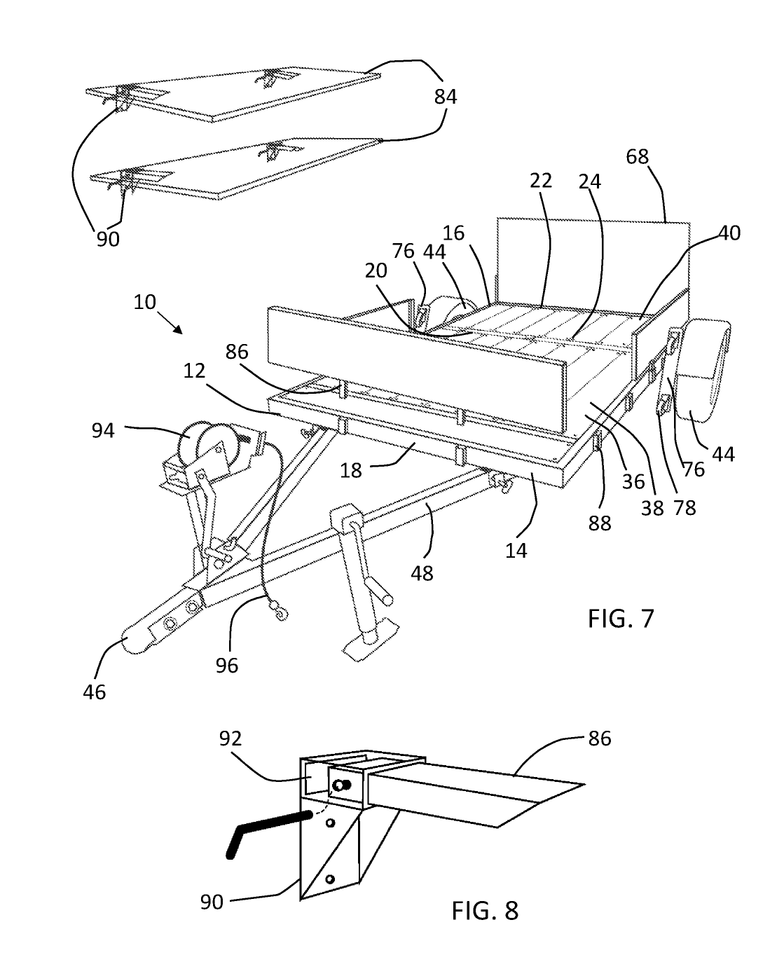

In the embodiment shown in FIG. 6 and FIG. 7, trailer 10 has removable side panels 84. Side panels 84 have connectors 86 that correspond to connector receptacles 88 on frame 12. The number of connectors 86 and receptacles 88 may vary depending upon the length of side panels 84 and the preference of users. Referring to FIG. 7, when not in use, removable side panels 84 are usable as shelving units. Brackets 90, such as those seen in FIG. 8, may be used to support side panels 84 on a wall or as part of a shelving unit. Referring to FIG. 8, brackets 90 have a receptacle 92 sized to correspond to connectors 86 on side panels 84 to hold side panels 84 in position. It will be understood by a person skilled in the art that different types of brackets or methods of hanging removable side panels may be used.

Referring to FIG. 1, a winch 94 is provided to assist with the folding of frame 12 into the storage orientation, shown in FIG. 3. In the embodiment shown, winch 94 is pivotally attached to stabilization bars 48. Winch 94 is movable between a working orientation, shown in FIG. 1, and a storage orientation, shown in FIG. 3. Referring to FIG. 1, in the working orientation, winch is positioned upright to allow for unobstructed use. Referring to FIG. 3, winch may be swung down such that it rests between stabilization bars 48 when not in use. Winch 94 may also be removed from stabilization bars 48 or may be separate from foldable utility trailer 10. Hand or motor operated winches may be used.

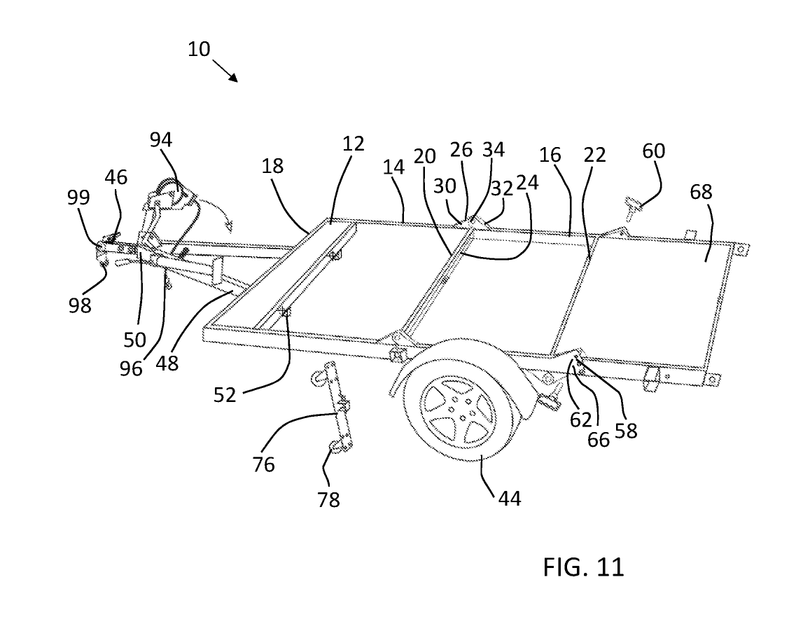

Referring to FIG. 11, a receiver wheel 98 is removably attachable to coupler 46 for use during the folding process. Prior to folding trailer 10, receiver wheel 98 is attached to coupler 46. In the embodiment shown, receiver wheel 98 has a ball 99 sized to be received by coupler 46. Receiver wheel 98 is able to rotate or pivot such that it contacts the ground during folding and maintains coupler 46 out of contact with the ground. Receiver wheel 98 prevents dragging of coupler 46 on the ground during folding. Receiver wheel 98 may be removed from coupler 46 once trailer 10 is in the storage orientation. Receiver wheel 98 is removed from coupler 46 prior to hitching up trailer 10 to a tow vehicle. A person of skill will understand that receiver wheel 98 may be attached to coupler 46 by any other means known in the art.

Moving from the hauling orientation, shown in FIG. 1, to the storage orientation, shown in FIG. 4, can be done manually or through the use of winch 94. In the embodiment of trailer 10 shown in FIG. 6, the first step is to remove side panels 84 from frame 12. Ramp 68 is folded down and may be locked in a horizontal orientation aligned with second segment 16 of frame 12 or may be removed. Removal of ramp 68 makes the folding process less cumbersome, however it will be understood that ramp 68 could remain attached to frame 12. Supports 76 are positioned adjacent forward end 24 of second segment 16 of frame 12 and locked into position using pins 82 through apertures 80. Receiver wheel 98 is attached to coupler 46 by inserting ball 99 into coupler 46 and locking it in place. When winch 94 is used it should either be positioned in front of coupler 46 (when separate from trailer) or moved to its working orientation. Winch wire 96 should be attached adjacent back end 22 of second segment 16. Winch 94 is operated to draw second segment 16 of trailer 10 upwards. This causes trailer 10 to begin to buckle between first segment 14 and second segment 16 and begins to move supports 76 into contact with the ground. Once supports 76 are resting on the ground, trailer wheels 44 are completely off the ground and second segment 16 is in the desired orientation, winching is stopped. Referring to FIG. 3, the desired orientation of second segment 16 is substantially vertical, however it will be understood by a person skilled in the art that some deviation from vertical is acceptable. Winch wire 96 can then be removed from second segment 16. Prior to folding first segment 14 of frame 12, stabilization bars 48 and coupler 46 are allowed to pivot in relation to first segment 14 by removing safety pins 56. To fold first segment 14 of frame 12 into the storage orientation winch 94 may be used. When winch 94 is attached to stabilization bars 48, winch wire 96 is fed under front segment 14 and attached to second segment 16 of frame 12 adjacent forward end 24. Pulleys, not shown, may be used to guide winch wire 96 and prevent snagging. Winch 94 is operated to draw stabilization bars 48 and couplers 46 into contact with an underside 98 of first segment 14 while causing first segment 14 to move towards substantially vertical second segment 16. Once first segment 14 is in the desired location, locking mechanism 58 is used to lock first segment 14 in relation to second segment 16. Winch wire 96 can be disconnected from second segment 16 of frame 12 and winch 94 stored as seen in FIG. 3. If ramp 68 has been removed, it is reattached to second segment 16. If ramp 68 was folded down and locked into a horizontal orientation, it is unlocked and allowed to fold downwards until it reaches a position substantially perpendicular to vertical second segment 16 to create work table surface 70, shown in FIG. 5 and FIG. 6. Removable legs or second section of ramp 74, when used, provide strength and support to work table surface 70. To unfold trailer 10, these steps may be completed in reverse.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A foldable utility trailer, comprising:
a frame having a front end, a back end, a first segment adjacent the front end and a second segment adjacent the back end, the first segment of the frame being pivotally attached to the second segment of the frame such that the frame is foldable between a storage orientation and a hauling orientation;
a trailer bed being supported by the frame, the trailer bed having a first portion corresponding to the first segment of the frame and a second portion corresponding to the second segment of the frame;
at least one axle attached to the frame, the axle having at least one wheel;
a coupler connected adjacent to the front end of the frame; and
a locking mechanism for locking the frame in the storage orientation.

2. The foldable utility trailer of claim 1 further comprising a ramp pivotally connected to the back end of the frame.

3. The foldable utility trailer of claim 2 wherein the ramp is foldable at a perpendicular angle to the second segment of the frame when in the storage orientation to create a work bench surface.

4. The foldable utility trailer of claim 2 wherein the ramp is removably connected to the back end of the frame.

5. The foldable utility trailer of claim 1 wherein the coupler is removably connected to the front end of the frame.

6. The foldable utility trailer of claim 1 wherein the coupler is spaced from the front end of the frame by at least one stabilization bar, the at least one stabilization bar having a first end attached to the coupler and a second end removably attached to the front end of the frame.

7. The foldable utility trailer of claim 1 wherein the first segment of the frame is twice as long as the second segment of the frame.

8. The foldable utility trailer of claim 2 wherein the ramp comprises a first section and a second section, the first section being connected to the back end of the frame, the first section being pivotally attached to the second section.

9. The foldable utility trailer of claim 8 wherein the second section of the ramp is in telescopic communication with the first section such that the second section of the ramp fits inside the first section of the ramp.

10. The foldable utility trailer of claim 8 wherein in the storage orientation the second section of the ramp is foldable at an angle perpendicular to the first section of the ramp such that it acts as a support for the first section of the ramp when folded to create the work bench surface.

11. The foldable utility trailer of claim 1 wherein at least one support is removably attachable to the frame adjacent a rear end of the first segment of the frame for supporting the frame when in the storage orientation.

12. The foldable utility trailer of claim 1 wherein at least one support is removably attachable to the frame adjacent a forward end of the second segment of the frame for supporting the frame when in the storage orientation

13. The foldable utility trailer of claim 11 wherein the at least one support has at least one wheel.

14. The foldable utility trailer of claim 1 further comprising removable side panels attached to the frame.

15. The foldable utility trailer of claim 14 wherein the removable side panels have at least one connector corresponding to at least one connector receptacle attached to the frame.

16. The foldable utility trailer of claim 14 wherein the removable side panels are usable as shelving units.

17. The foldable utility trailer of claim 1 wherein the axle is attached to the second segment of the frame adjacent the forward end of the second segment of the frame.

18. The foldable utility trailer of claim 1 wherein the locking mechanism comprises a removable pin, a first locking aperture in communication with the second segment of the frame and a second locking aperture in communication with the first segment of the frame, the removable pin being sized to slide into the first locking aperture and the second locking aperture.

19. The foldable utility trailer of claim 1 wherein a winch is used to fold the frame into the storage orientation.

20. The foldable utility trailer of claim 1 wherein a receiver wheel is removably attachable to the coupler.
